(19) United States
(12) Patent Application Publication
(10) Pub. No.: US 2023/0160635 A1
(43) Pub. Date: May 25, 2023

(54) DEVICE FOR DRYING AND/OR DISINFECTING OBJECTS

(71) Applicant: Steurer Trocknungs-Und Aufbewahrungs- Systeme GmbH, Altach (AT)

(72) Inventor: Andreas SEIDL, Viktorsberg (AT)

(73) Assignee: Steurer Trocknungs- Und Aufbewahrungs- Systeme GmbH, Altach (AT)

(21) Appl. No.: 18/153,570

(22) Filed: Jan. 12, 2023

Related U.S. Application Data
(63) Continuation of application No. PCT/EP2021/064856, filed on Jun. 2, 2021.

(30) Foreign Application Priority Data
Jul. 16, 2020 (DE) 10 2020 118 881.1

(51) Int. Cl. F26B 9/06; F26B 21/08; F26B 21/04; D06F 58/10

(52) U.S. Cl. CPC F26B 9/06; F26B 21/086; F26B 21/04; D06F 58/10

(57) ABSTRACT

The invention relates to a device for drying and/or for disinfecting objects, comprising a cabinet having a receiving chamber through which a gas can flow, and a fan unit, a heating device being provided for heating the gas. According to the invention, a dehumidifying unit is provided for the condensation drying of the gas, and a gas treatment chamber of the cabinet is provided which, in the installed state of the cabinet, is situated behind the receiving chamber, wherein the gas treatment chamber is separated from the receiving chamber by a partition, the heating device is provided in the gas treatment chamber for heating the gas in the gas treatment chamber, and the heated gas flows from the gas treatment chamber into the receiving chamber.

### CROSS REFERENCE TO RELATED APPLICATIONS

This application is a continuation of International Application No. PCT/EP2021/064856 filed Jun. 2, 2021, which designated the United States, and claims the benefit under 35 USC § 119(a)-(d) of German Application No. 10 2020 118 881.1 filed Jul. 16, 2020, the entireties of which are incorporated herein by reference.

### FIELD OF THE INVENTION

The present invention relates to a device for drying and/or disinfecting objects.

### BACKGROUND OF THE INVENTION

In the case of devices used to dry and/or disinfect objects, different operating principles and methods are used, whereby the configuration of the respective drying and hygiene systems also differs.

In the case of items of clothing, for example, in private households, the items of clothing are dried in a rotating drum, through which hot air is blown.

For other applications or objects, such drying is not practical, for example, because, owing to the movement during the drying operation, the objects to be dried themselves become damaged or are battered by other objects and the drum or are subjected to undesired wear, this being disadvantageous.

For such cases, for example, use is made of drying cabinets in which the objects to be dried are accommodated and not moved.

Furthermore, there are drying devices which perform microbial reduction on the objects to be dried, this being realized, for example, by heating them to a germicidal temperature.

The technical and economic challenges to be taken into consideration in previously known devices cannot be practically overcome in all cases.

CH 690038 A5, EP 2102405 A1, DE 102012003557 A1 and DE 2919762 A1 are cited as prior art.

### SUMMARY OF THE INVENTION

It is an object of the present invention to design devices mentioned in the introduction and to improve them from technical and economic perspectives in such a way that the devices meet professional demands and are user-friendly, in particular, the reliable drying and/or hygiene function of which is possible.

The starting point of the present invention is an apparatus for drying and/or disinfecting objects such as clothing, masks, footwear and protective helmets, comprising a cabinet having a receiving space through which a gas can flow and which is intended to temporarily accommodate the objects for the drying and/or disinfection of the objects in the cabinet, and a fan unit, which moves the gas predefinably along a flow path of the gas, in accordance with the circulation principle, in the interior of the cabinet, wherein the gas comes into contact with the objects in order to dry and/or disinfect the objects, wherein a heating device is provided to heat the gas.

The gas necessary for drying and/or disinfecting the objects is preferably air or ambient air. The apparatus is configured such that the gas within the cabinet is guided or flows preferably in a closed circuit or in the closed flow circuit. A partially open circuit for the flowing gas, however, is not ruled out, or can be set up selectively. In this case, for example, a preferably small fraction of all of the gas present in the cabinet can be exchanged for a gas outside the cabinet. The gas exchange can take place continuously and/or in phases.

The cabinet is preferably box-like. The cabinet has an interior which is closed, in particular, on all sides, outwardly or in relation to its surroundings by walls during working operation. The cabinet preferably has outer sides comprising a bottom on the underside and a top or a roof vertically spaced apart from the bottom and facing the latter. Between the bottom and the top there are outer walls of the cabinet, comprising, at the front, a cabinet door pivotable about a vertical axis or two cabinet doors, two oppositely situated cabinet side walls adjoining the door or the doors and present on the side of the cabinet, and, at the rear of the cabinet or facing the doors, a rear wall connecting the two side walls. The walls of the cabinet are preferably made from a corrosion-resistant, rust-resistant metal material, such as a galvanized metal sheet or a stainless steel material.

The core of the present invention is that a dehumidification unit for condensation drying the gas is present, and wherein, behind the receiving space in relation to the mounted state of the cabinet, there is a gas treatment space of the cabinet, wherein the gas treatment space is separated from the receiving space by a partition, wherein the heating device for heating the gas in the gas treatment space is provided in the gas treatment space, wherein the heated gas flows from the gas treatment space to the receiving space. Such an arrangement is advantageous for various reasons. According to the present invention, the apparatus has a compact structure for accommodating the heating device. The apparatus according to the present invention, which is preferably a mobile, mountable cabinet apparatus, is moreover advantageous in terms of the mode of operation of the drying and disinfection.

When the gas is dehumidified by condensation drying, the gas guided past cold heat exchanger surfaces is cooled down and gives off water in the form of condensate.

In the following text, the term “cabinet apparatus” will be used synonymously with the term “apparatus” regarding the subject matter of the present invention. Directional indications or spatial indications, unless defined otherwise, also relate to a mounted or use state of the cabinet apparatus, which stands upright by way of a bottom underside that is supported on a building floor, for example, in the mounted state of the apparatus.

The cabinet apparatus according to the present invention can, moreover, have a visually appealing design.

The cabinet apparatus according to the present invention is preferably designed in such a way that the cabinet apparatus can be operated in an environment in which the ambient temperature is between about 5° Celsius and about 30° Celsius.

The cabinet apparatus according to the present invention or the cabinet has an individually predefinable and comparatively small width. The gas treatment space, which, in particular, forms a double rear wall of the cabinet, extends in the width direction of the apparatus, determined by the horizontal spacing between the cabinet side walls, over preferably the entire width of the receiving space behind the receiving space. The gas treatment space is preferably provided exclusively on the rear side of the cabinet, adjoining the receiving space to the rear or not going beyond the width of the receiving space.

The cabinet apparatus according to the present invention or the cabinet preferably has a standard width and/or standard height. The width and/or the height of the gas treatment space preferably corresponds at least approximately to the width and/or the height of the receiving space.

If appropriate, the height of the gas treatment space is only somewhat smaller, for example, about 10 percent smaller, than the height of the receiving space. Above the gas treatment space and behind the receiving space, a space with a smaller height is preferably allocated to the positioning of a fan or of two or more fans.

Accordingly, the cabinet preferably has a double or second rear wall. The gas treatment space is present in such a way that the gas treatment space fills a part of the cabinet that is separated from other regions.

The separated part of the cabinet, or the gas treatment space, is present between the floor and the roof and between a forwardly first rear wall, which is a rear wall of the receiving space, and an outer rear wall of the cabinet and fills this part, which forms e.g. a chamber of the cabinet that is surrounded by walls.

Furthermore, the cabinet apparatus according to the present invention has a superordinate computer-assisted monitoring unit for monitoring, or providing open loop and closed loop control for, the cabinet apparatus, in particular, for the operation of electrically operated components for drying and disinfecting the objects.

The cabinet apparatus according to the present invention is advantageously adaptable to different environmental conditions, such as, in particular, a predefined space available for mounting the cabinet apparatus.

The gas or the air flows in the interior of the cabinet in accordance with the flow profile predefined by the fan unit, circulating from the gas treatment space, in which the gas is heated by the heating device preferably to above 30 degrees Celsius, through openings in the partition, such as a thin intermediate rear wall, and into the receiving space, where the gas flows past the wet or damp objects and dehydrates them in that water is taken up by the gas and the objects are continuously dried during gas circulation operation of the apparatus.

The water is then taken up in the hot gas as steam. In order that the maximum possible water load is not reached, which would mean that the gas takes up no further water and thus the drying stops, the moisture-laden gas is dehumidified by condensation by means of the dehumidification unit, involving a reduction in temperature or cooling down of the gas.

The dehumidification unit for condensation drying accordingly comprises an arrangement for condensing the gaseous moisture in the circulating gas. Gas or air at a low temperature can take up less moisture compared with the same amount of gas at a higher temperature. To condense the gaseous water in the circulating gas that was yielded to the gas by the objects, a heat exchanger having cooled surface regions is provided. The temperature of the surface regions is, for example, somewhat above zero degrees Celsius, such as preferably e.g. about 2 degrees Celsius. The gas flows past the cold surfaces, cools down and discharges condensed water. The gaseous water becomes liquid, or forms a condensate which impacts or collects on the heat exchanger surfaces as droplets. A temperature of the surfaces of above zero degrees Celsius has the advantage that undesired icing of the surfaces is counteracted. The gas cooled down on the cold surfaces of the heat exchanger cools down to e.g. 5 to 15 degrees Celsius.

A further core aspect can be considered that of a plasma generator of the apparatus being provided to disinfect the objects by means of the gas, wherein the plasma generator generates a plasma which reduces the number of microbes in the circulating gas, and/or the gas exhibits a microbial reduction action.

This avoids microbial contamination, originating from the objects, of the surroundings in which the cabinet apparatus is accommodated. Moreover, effective and reliable disinfection of the objects is achieved. In particular, it is advantageously not necessary to use a chemical product or ozone for disinfection purposes. Up to now, expensive chemical products which in some cases are environmentally disadvantageous were used to disinfect objects. These chemical products moreover require additional devices and regular monitoring and delivery of the chemical product. Accordingly, a plasma generator, which requires merely an electrical voltage and a process gas that is ionized, is advantageous. The process gas is preferably formed by the circulating gas or by the circulating air, this being present in any case.

The use of the plasma generator is associated with further advantages.

The plasma reduces the number of microbes in the circulating gas or the air itself, since microbes are generally already present as a kind of permanent principal load in the gas or the air, as is the case e.g. in the natural atmosphere or in conventional surroundings.

However, the plasma, in particular, additionally reduces microbes that enter the gas and are transferred into the gas from the objects to be disinfected. The microbes and all other organisms are rendered harmless or killed in the gas by the plasma.

Lastly, such a plasma dose is at least temporarily provided in the gas or in the air by means of the plasma generator that the gas or the air with the incorporated plasma kills, eliminates or renders harmless active microbes present on the objects as it flows past cabinet surfaces or the objects. The ionized gas itself acts on all surfaces over which the gas passes in a microbially reducing manner, whereby surfaces of the objects and the apparatus past which the gas flows are disinfected. Owing to the plasma, the plasma gas also acts advantageously as a cleaning agent for the interior of the apparatus or of the cabinet along the flow path of the gas.

It is advantageous if the plasma generator is arranged in the gas treatment space. As a result, plasma is provided in the region in which the gas is flowing, upstream of where it passes through into the receiving space and thus shortly before the plasma-treated gas makes contact with the objects. This achieves effective disinfection of the objects.

Moreover, the plasma generator is thus accommodated in the cabinet so as to be protected against damage. The plasma generator is advantageously separated from the receiving space by the partition and cannot be adversely affected when objects are being introduced into and removed from the receiving space.

Given corresponding or comparatively high plasma power and/or circulation intensity of the gas in the cabinet, it is even possible to completely or virtually completely rid cabinet inner surfaces and/or the objects of microbes.

The superordinate, computer-assisted control unit is preferably designed in such a way that the plasma generator or the plasma source can be regulated separately. The electrically operated plasma generator is configured correspondingly settably or adaptably in terms of its power, or it is advantageously possible to modify the plasma power or to set it to a respective desired operating value.

It is advantageous when a dehumidification unit for condensation drying the gas is present. In this way, in addition to the advantageous disinfection by means of plasma, effective drying of the circulating gas is effected.

According to an advantageous modification, a compression refrigeration machine having a refrigerant circulating in a closed cooling circuit is provided.

In this way, the apparatus can be operated reliably, since a sound technique that has proven successful is used. A compression refrigeration machine is commercially obtainable and economically advantageously available in various modifications and power classes.

The compression refrigeration machine is operated with a preferably environmentally friendly refrigerant which is moved in a closed circuit in a line-bound manner.

The compression refrigeration machine comprises heat transfer surfaces, an evaporator, a compressor and a condenser and further components, such as valves. Mechanical work is introduced from the outside as drive power by the compressor.

When the refrigerant is evaporating at low temperature, heat is extracted from the gas or the air, which discharges water in the form of condensate. This is effected by means of the dehumidification unit for dehumidifying the gas at a cooled heat transfer surface, which reaches into or adjoins the condensation space.

The dry gas is heated in one stage or two stages.

Advantageously, the compression refrigeration machine can provide the heating device. In addition to the heating by an electric heating device, the gas is preferably heated by means of waste heat from the compression refrigeration machine.

This saves energy, since the waste heat from the compression refrigeration machine is not discharged to the outside, for example, to the atmosphere, but rather is used to heat the previously cooled-down gas.

The condenser with refrigerant guided therein in a corresponding, preferably spiral-shaped or helical pipeline, which provides the heat exchanger surfaces, is preferably accommodated in the gas treatment space or the double rear wall.

The compressor is also preferably present in the gas treatment space. The operating noises of the compressor thus scarcely reach the outside.

Another advantage is produced in that, above the receiving space and or above the gas treatment space in relation to the mounted state of the cabinet, there is a condensation space through which the gas can flow and which comprises the dehumidification unit, wherein the condensation space is separated from the receiving space by a partition, wherein the dehumidification unit serves to condense the moisture in the gas flow guided from the receiving space to the condensation space. An intermediate base, such as a base plate, e.g. a condensate collection tray, is preferably present between the receiving space and the condensation space. Such an arrangement is advantageous from a structural and visual perspective.

Furthermore, the condensed water precipitating or continuously forming in the condensation space flows into a container, situated at a lower level, for collecting the condensate advantageously under the action of gravity alone, without an auxiliary device. A condensate pump or the like is not necessary.

The dehumidification unit or the condensation unit has the effect of condensation drying the gas, wherein the gas or the air is cooled by means of the heat exchanger and water is separated off from the moisture-laden gas.

In order that the cooled-down gas can continue to take up water from the damp objects, it must be heated. The gas is preferably heated, in the flow direction of the gas, downstream of the condensation or outside of the condensation space in the gas treatment space arranged downstream of the condensation space in the gas flow direction.

The heating device comprises, for example, an electric heater or heating device which is provided downstream of the gas cooling and upstream of where the circulating gas makes contact with the objects in the flow direction of the gas.

It is, moreover, advantageous when the dehumidification unit comprises an evaporator unit of the compression refrigeration machine, wherein the evaporator unit is accommodated in the condensation space. In this way, the condensation is provided in an economically advantageous way. The condensate or condensed water that has formed on an external heat exchanger surface of the evaporator unit drips downward onto, for example, a collection plate and flows from there into a channel opening into a hose or a line. The condensate flows through the hose or the line downward into a container, which is removably present, for example, on the inside of a door of the cabinet apparatus, in order to empty it from time to time. There is space for a comparatively large amount of condensate in the condensate container.

Another advantage is produced when the fan unit is present between the condensation space and the gas treatment space. The fan unit is preferably provided in a separate region behind the condensation space and above the gas treatment space. One fan, or exactly two or more fans or blowers, is or are preferably present. The at least one fan draws in the cooled-down gas that has been dried by the evaporator via a connection to the condensation space that is open to the gas and blows the gas into the gas treatment space. Accordingly, the gas treatment space forms a pressure space or pressure body of the apparatus in which the gas has a comparatively somewhat elevated gas pressure. The fan unit also effects a predefined gas flow and deflection of the gas. The fan unit is preferably designed to draw in the gas in the horizontal direction and push it away downward in the vertical direction.

The fan unit is preferably accommodated completely inside the cabinet, for example, in the corner region between an outer top and an outer rear wall of the cabinet.

Moreover, it is advantageous that the heating device comprises a condenser unit of the compression refrigeration machine, wherein the condenser unit is arranged in the gas treatment space. In this way, the compression refrigeration machine is optimally integrated in the apparatus or in the cabinet. A heat exchanger, through which the refrigerant flows, of the condenser unit comprises, for example, a helical pipe.

According to an advantageous modification of the present invention, a compressor member of the compression refrigeration machine is present, wherein the compressor member is arranged in the gas treatment space. The compressor member is preferably a conventional compressor as it is standard practice to use for compression refrigeration machines.

An advantageous variant of the present invention is also produced when the heating device comprises a heater, which is arranged in the gas treatment space. The preferably electric heater preferably has a temperature limiter for delimiting the temperature range within which the temperature to which the gas is to be heated lies.

The target or setpoint temperature of the heated, dry gas, as it flows into the receiving space, is in the region above 20 degrees Celsius, preferably above 30 degrees Celsius, preferably is at about 33 degrees Celsius.

The heater is preferably operated temporarily, for example, in addition to the heating of the gas using the condenser.

The gas is generally or preferably continuously heated by means of the condenser.

Accordingly, the circulating gas is continuously heated substantially by means of the condenser of the compression refrigeration machine. The heat exchanger of the condenser has, for example, a temperature of about 60 degrees Celsius. When the heat generated in the process is not enough to bring the gas to the setpoint temperature, the heater is switched on. The additional heater is switched off when the setpoint gas temperature is exceeded.

It is advantageous when a condensate collecting tray and a condensate accumulating container are present. In this way, the water that has condensed in the condensation space is collected and accumulated in a controlled manner and can be constantly supplied for further use and/or disposal. The condensate drips from above the preferably oblique or inclined condensate collecting tray onto the condensate collecting tray and runs directly thereon or via a channel, such as a collecting channel or the like, toward the condensate accumulating container. The water therefore cannot accumulate uncontrolledly in the cabinet at different locations and possibly lead to undesired phenomena, such as corrosion, mold formation or unpleasant odors, there.

The condensate accumulating container is detachably but fixedly present in the cabinet preferably on the inside of, for example, a cabinet door, and, when the door is opened, a person can remove it without problems and easily by hand, so that the container can be emptied and then reattached.

The condensate accumulating container is additionally or alternatively connected on the runout side to a discharge line by way of an outlet, for example, in order to introduce the condensate into a wastewater line. Then, manual emptying can be dispensed with and disadvantageous overflowing of the container when the surface of the accumulated condensate rises, possibly as far as back to the condensate collecting tray, is ruled out.

Between the condensate collecting tray or the accumulating channel connected thereto, wherein both elements are preferably accommodated in the condensation space or form part thereof, there is provided a condensate discharge line, for example, a flexible hose, within which the condensate flows out of the accumulating channel to the condensate accumulating container independently under the action of gravity.

It has also proven advantageous when hollow hang-up fittings for attaching the objects in the receiving space are present in the receiving space, wherein the hang-up fittings are attached to the partition between the receiving space and the gas treatment space. The preferably elongate and narrow hang-up fittings project beyond the partition into the receiving space, for example, somewhat obliquely forward and upward. The objects, such as, for example, skiing and/or snowboarding equipment, can comfortably be hung up on the hang-up fittings by hand from the front when the doors are open. Hanging options for clothes hangers received thereon are preferably additionally provided to suitably hang up items of clothing in the receiving space, such as ski jackets, ski trousers, overalls and the like. The clothes hangers are preferably hollow and designed so that dry gas coming from the gas treatment space can flow through them. Through outlet openings in the clothes hangers, the hot, dry gas flows out of the interior of the clothes hangers, past the associated hung-up item of clothing, into the receiving space, and in so doing carries moisture from the item of clothing along with it.

The hang-up fittings can be shaped so as to individually match different objects, for the purpose of hanging up, for example, ski boots, ski helmets, gloves, ski goggles and the like.

The hollow hang-up fittings are approximately tubular, for example. Advantageously, the dry, hot gas can flow through the hang-up fittings.

The hang-up fittings are connected to the gas treatment space by way of their inner cavity via gas-permeable openings in the partition.

In addition, openings may be provided in the partition, such as the rear wall, in regions next to the hang-up fittings.

Owing to the gas that is flowing or the somewhat higher gas pressure in the gas treatment space compared with the gas pressure in the receiving space, the gas flows through the openings in the partition into the hang-up fittings and from there, through preferably multiple outlets or openings in the hang-up fittings, continues past the surfaces of the objects hung up on the hang-up fittings. The gas therefore effectively takes up the moisture from the objects and dries them.

The partition is preferably an inner, in particular vertical, narrow intermediate rear wall of the cabinet apparatus or of the cabinet.

It is moreover expedient that the fan unit and flow paths for the gas in the cabinet are matched in such a way that the gas in the receiving space flows vertically upward toward the condensation space. This enables effective drying of the objects and dehumidification of the gas in the upper condensation space of the cabinet.

Lastly, it is advantageous that the fan unit and flow paths for the gas in the cabinet are matched in such a way that the gas in the gas treatment space flows vertically downward. This enables effective space utilization in the cabinet when the gas is circulating by way of the condensation of the gas moisture above the receiving space.

### BRIEF DESCRIPTION OF THE DRAWINGS

Further advantages and features of the present invention are explained in more detail on the basis of the description of a schematically illustrated exemplary embodiment according to the present invention.

FIG. 1 shows a perspective view, obliquely from the front, of an open apparatus according to the present invention in the form of a condensation drying cabinet;

FIG. 2 shows the condensation drying cabinet according to FIG. 1 from the front;

FIG. 3 shows a side view of the closed condensation drying cabinet according to FIG. 1 omitting a side wall of the condensation drying cabinet;

FIG. 4 shows a rear view of the condensation drying cabinet according to FIG. 3 omitting an outer rear wall of the condensation drying cabinet;

FIG. 5 shows a perspective detail of the top of the condensation drying cabinet according to FIG. 3; and

FIG. 6 shows a further perspective detail, illustrated as open to the front, of the top of the condensation drying cabinet according to FIG. 3.

### DETAILED DESCRIPTION OF THE INVENTION

An apparatus 1 according to the present invention for drying and/or disinfecting objects, such as clothing, footwear and protective helmets, is in the form of a condensation drying cabinet 2.

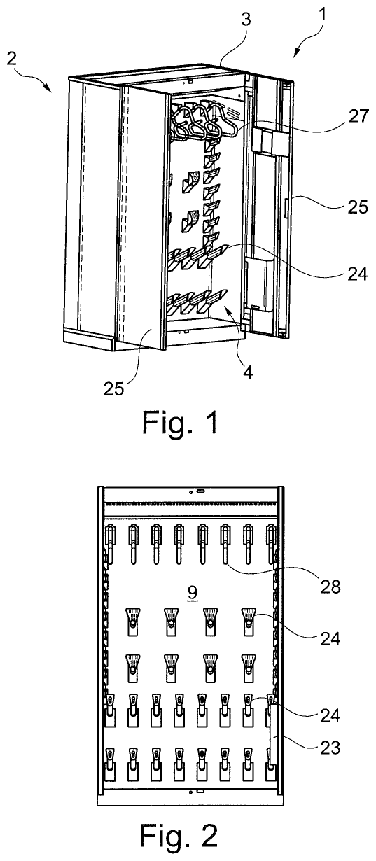

The condensation drying cabinet 2 comprises a cabinet 3 with a receiving space 4, through which a gas G can flow and which is intended to temporarily accommodate the objects for the drying and/or disinfection of the objects in the cabinet 3. The cabinet 3 has two pivotable swing doors 25, which are open in FIGS. 1 and 2.

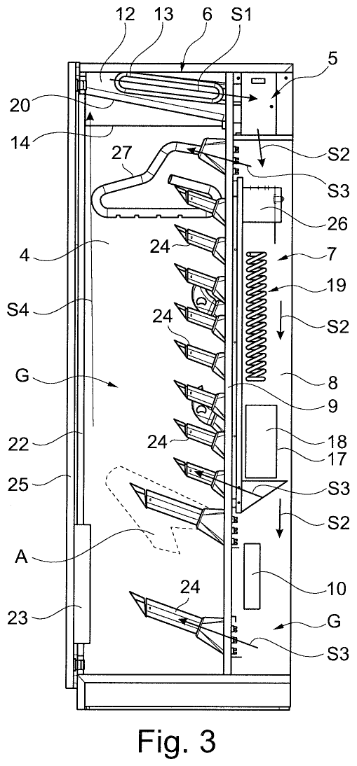

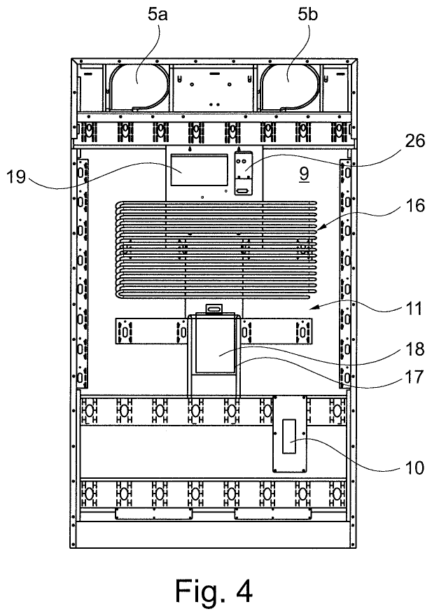

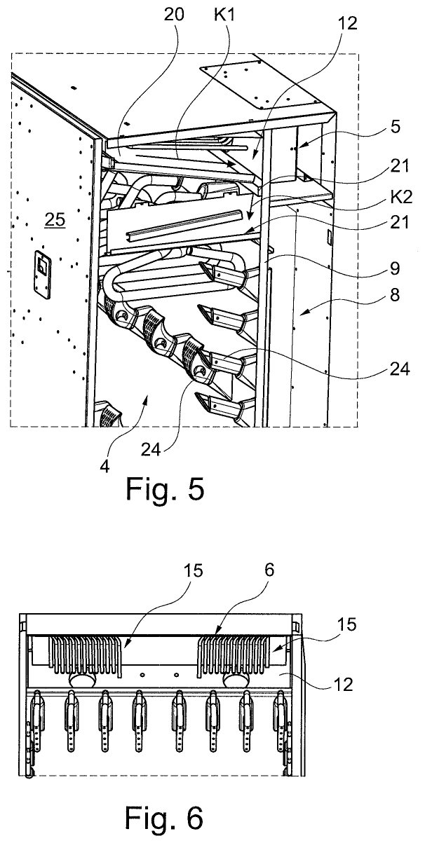

Moreover, a fan unit 5 with two fans 5a and 5b, which moves the gas G predefinably along a flow path S1 to S4 of the gas G, in accordance with the circulation principle, in the interior of the cabinet 3, is part of the condensation drying cabinet 2. In the process, the gas G comes into contact with the objects, only one object, such as a ski boot A, of which is indicated schematically and in dashed line on a shoe holder hang-up fitting 24 in FIG. 3, in order to dry and/or disinfect the objects.

Furthermore, there is a dehumidification unit 6 with a condensation surface which is in the form of a heat exchanger surface 13 and is intended for condensation drying of the gas G. The heat exchanger surface 13 is in the form of a helical, hollow pipe through which a refrigerant flows.

To heat the gas G, there is a heating device 7.

Behind the receiving space 4 in relation to the mounted state, illustrated in the figures, of the apparatus 1 or of the cabinet 3, there is a gas treatment space 8 of the cabinet 3, wherein the gas treatment space 8 is separated from the receiving space 4 by a partition 9. The gas treatment space 8 forms a pressure space with elevated gas pressure between double and spaced-apart vertical rear walls of the cabinet 3.

The heating device 7 for heating the gas G in the gas treatment space 8 is provided in the gas treatment space 8, wherein the heated gas G flows from the gas treatment space 8 into the receiving space 4 in accordance with the predefined flow direction S3 of the gas G.

To disinfect the objects by means of the gas G, a plasma generator 10 of the apparatus 1 is provided in the gas treatment space 8. The plasma generator 10 generates a plasma which reduces the number of microbes in the circulating gas G, and/or the gas G exhibits a microbial reduction action. This leads to the objects being rid of microbes on the surfaces around which the gas G flows, in particular, in that the microbes are transferred to the gas G and eliminated there by the plasma action of the plasma generated by the plasma generator 10.

A compression refrigeration machine 11 having a refrigerant circulating in a closed cooling circuit of the compression refrigeration machine 11 is provided in the condensation drying cabinet 2.

Above the receiving space 4, there is a condensation space 12 through which the gas G can flow and which comprises the dehumidification unit 6 and the heat exchanger surfaces 13, wherein the dehumidification unit 6 provides a heat exchanger surface 13 that is at a cool temperature of about 2 degrees Celsius. The condensation space 12 is separated from the receiving space 4 by a partition 14 through which or around the sides of which the gas G can flow via openings. The dehumidification unit 6 with the heat exchanger surface 13 serves to condense the moisture in the gas flow guided out of the receiving space 4 into the condensation space 12.

The dehumidification unit 6 comprises an evaporator unit 15 of the compression refrigeration machine 11, wherein the evaporator unit 15 is accommodated in the condensation space 12 and acts as a dehumidification unit 6.

The fan unit 5 is present above the gas treatment space 8, between the condensation space 12 and the gas treatment space 8.

The heating device 7 comprises a condenser unit 16 of the compression refrigeration machine 11, which gives off heat to and heats the cooled-down, dry gas G via heat exchanger surfaces that are at a warm temperature of about 60 degrees. The condenser unit 16 is arranged in the gas treatment space 8.

A compressor member 17, in the form of a compressor 18, of the compression refrigeration machine 11 is arranged in the gas treatment space 8.

In addition to the condenser unit 16, the heating device 7 comprises a preferably electric heater 19 having a temperature limiter 26, which is arranged in the gas treatment space 8. After flowing past the heating device 7, the gas G has a setpoint temperature of about 33 degrees Celsius.

There is a condensate collecting tray 20 in the condensation space 12. A condensate accumulated on the obliquely aligned condensate collecting tray 20, in accordance with K1 and with a deflection K2, enters a channel 21 and from there a condensate discharge line 22 (see FIG. 3) connected thereto, for example, a flexible hose opening into a condensate accumulating container 23.

To attach the objects in a manner hung up in the receiving space 4, hollow hang-up fittings 24 and hollow hanger hang-up means 27 are present in the receiving space 4.

The hang-up fittings 24 are attached to the partition 9 or to the front, or inner, rear wall between the receiving space 4 and the gas treatment space 8.

The fan unit 5 and flow paths for the gas G in the cabinet 3 are matched in such a way that the gas G in the receiving space 4 flows vertically upward toward the condensation space 12 in accordance with S4. In particular, the gas G in the gas treatment space 8 flows vertically downward in accordance with S2, then into the receiving space 4, from there into the condensation space 12 in accordance with S1, and back into the gas treatment space 8 again by means of the fan unit 5.

### LIST OF REFERENCE SIGNS

1 Apparatus
2 Condensation drying cabinet
3 Cabinet
4 Receiving space
5 Fan unit
5a Fan
5b Fan
6 Dehumidification unit
7 Heating device
8 Gas treatment space
9 Partition
10 Plasma generator
11 Compression refrigeration machine
12 Condensation space
13 Heat exchanger surface
14 Partition
15 Evaporator unit
16 Condenser unit
17 Compressor member
18 Compressor
19 Heater
20 Condensate collecting tray
21 Channel
22 Condensate discharge line
23 Condensate accumulating container
24 Hang-up fittings
25 Swing door
26 Temperature limiter
27 Hanger hang-up means

1. An apparatus for drying and/or disinfecting objects such as clothing, masks, footwear and protective helmets, comprising a cabinet with a receiving space through which a gas can flow and which is intended to temporarily accommodate the objects for the drying and/or disinfection of the objects in the cabinet, and a fan unit, which moves the gas predefinably along a flow path of the gas, in accordance with the circulation principle, in the interior of the cabinet, wherein the gas comes into contact with the objects in order to dry and/or disinfect the objects, wherein a heating device is provided to heat the gas, wherein a dehumidification unit for condensation drying the gas is present, wherein a gas treatment space is separated from the receiving space by a partition, wherein the heating device is provided in the gas treatment space for the purpose of heating the gas in the gas treatment space, wherein the heated gas flows from the gas treatment space to the receiving space, wherein the condensation space is separated from the receiving space by a partition, wherein the dehumidification unit serves to condense the moisture in the gas flow guided from the receiving space to the condensation space, wherein the apparatus is configured such that the gas within the cabinet flows in a closed circuit, wherein, behind the receiving space in relation to the mounted state of the cabinet, there is the gas treatment space of the cabinet, wherein a plasma generator of the apparatus is provided to disinfect the objects by means of the gas, wherein the plasma generator generates a plasma which reduces the number of microbes in the circulating gas, and/or the gas exhibits a microbial reduction action, wherein the plasma generator is arranged in the gas treatment space, wherein, above the receiving space and above the gas treatment space in relation to the mounted state of the cabinet, there is a condensation space through which the gas can flow and which comprises the dehumidification unit, wherein a compression refrigeration machine having a refrigerant circulating in a closed cooling circuit is provided, wherein the heating device comprises a condenser unit of the compression refrigeration machine, wherein the condenser unit is arranged in the gas treatment space, wherein the heating device comprises a heater, which is arranged in the gas treatment space, wherein the heater, which is operated temporarily, is additionally provided to continuously heat the gas by means of the condenser unit.

2. The apparatus as claimed in claim 1, wherein the dehumidification unit comprises an evaporator unit of the compression refrigeration machine, wherein the evaporator unit is accommodated in the condensation space.

3. The apparatus as claimed in claim 1, wherein the fan unit is present between the condensation space and the gas treatment space.

4. The apparatus as claimed in claim 1, wherein a compressor member of the compression refrigeration machine is arranged in the gas treatment space.

5. The apparatus as claimed in claim 1, further comprising a condensate collecting tray and a condensate accumulating container.

6. The apparatus as claimed in claim 1, further comprising hollow hang-up fittings in the receiving space for attaching the objects in the receiving space, wherein the hang-up fittings are attached to the partition between the receiving space and the gas treatment space.

7. The apparatus as claimed in claim 1, wherein the fan unit and flow paths for the gas in the cabinet are matched in such a way that the gas in the receiving space flows vertically upward toward the condensation space.

8. The apparatus as claimed in claim 1, wherein the fan unit and flow paths for the gas in the cabinet are matched in such a way that the gas in the gas treatment space flows vertically downward.
